(19) United States
(12) Patent Application Publication
(10) Pub. No.: US 2007/0091645 A1
(43) Pub. Date: Apr. 26, 2007

(54) EDGE-TYPE BACKLIGHT MODULE WITH A LOCK MECHANISM FOR COMBINING A LIGHT GUIDE PLATE WITH A BACKING PLATE

(76) Inventors: Yi-Ching Chang, Taipei Hsien (TW); Chih-Chun Hsiao, Kao-Hsiung Hsien (TW); Cheng-Min Liao, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 11/163,604

(22) Filed: Oct. 25, 2005

(51) Int. Cl. F21V 7/10

(52) U.S. Cl. 362/632; 362/600; 362/216

(57) ABSTRACT

An edge-type backlight module includes a light guide plate including a first lock mechanism, a backing plate installed on one side of the light guide plate including an opening located in a position corresponding to a position where the first lock mechanism is located, and a second lock mechanism for fixing the light guide plate and the backing plate with the first lock mechanism in a locking manner.

### BACKGROUND OF THE INVENTION

1. Field of the Invention

The present invention relates to an edge-type backlight module with a lock mechanism for combining a light guide plate with a backing plate, and more particularly, to an edge-type backlight module, which utilizes nuts combined with a light guide plate through an injection molding process and bolts to combine the light guide plate with a backing plate.

2. Description of the Prior Art

Backlight units are known in the art. The backlight unit, which is a key element in the fabrication of liquid crystal displays (LCDs), is widely used in monitors, notebooks, digital cameras, projectors and so on. Backlight units are typically divided into two major categories: edge-type and direct-type, wherein a light source of the edge-type backlight unit is positioned on the lateral side of the display panel so as to reduce the size and cost of the liquid crystal display.

Please refer to FIG. 1. FIG. 1 is a diagram of an edge-type backlight module 10 in the prior art. The edge-type backlight module 10 includes a light guide plate 12 and a plurality of straight fluorescent tubes 14 installed on the lateral side of the light guide plate 12. The straight fluorescent tube 14 can be a cold cathode fluorescent lamp (CCFL). The straight fluorescent tubes 14 installed on the lateral sides of the light guide plate 12 are the light source of the edge-type backlight module 10. The straight fluorescent tubes 14 are often positioned on an upper side or a bottom side of the light guide plate 12 or on both sides of the light guide plate 12.

Please refer to FIG. 2. FIG. 2 illustrates the combination of the light guide plate 12 and a backing plate 16 of the edge-type backlight module 10 in the prior art. The backing plate 16 is installed below the light guide plate 12 for covering the light guide plate 12 and internal components of the edge-type backlight module 10. An end of the backing plate 16 is bent to form an ear part so that an ear part 18 of the light guide plate 12 can be wedged into the ear part in a side without positioning tubes of the light guide plate 12. However there is a gap between the light guide plate 12 and the backing plate 16 in the above-mentioned assembling mechanism so that the vibration and impulse resistance strength decreases. Furthermore, it is unable to position the straight fluorescent tube 14 on the side where the light guide plate 12 and the backing plate 16 are combined by the above mentioned assembling mechanism, meaning that the illuminance of the edge-type backlight module 10 can not be increased.

### SUMMARY OF THE INVENTION

It is therefore a primary objective of the claimed invention to provide an edge-type backlight module with a lock mechanism for combining a light guide plate with a backing plate for solving the above-mentioned problem.

According to claimed invention, an edge-type backlight module includes a light guide plate including a first lock mechanism, a backing plate installed on one side of the light guide plate including an opening located in a position corresponding to a position where the first lock mechanism is located, and a second lock mechanism for fixing the light guide plate and the backing plate with the first lock mechanism in a locking manner.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of an edge-type backlight module in the prior art.

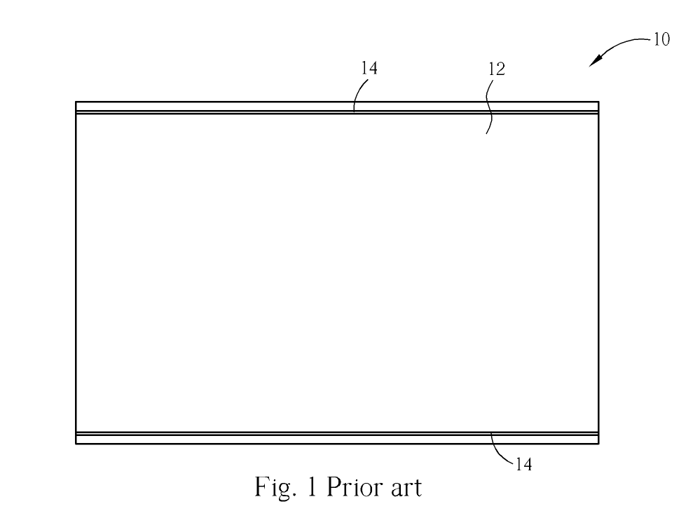

FIG. 2 illustrates the combination of a light guide plate and a backing plate of the edge-type backlight module of FIG. 1 in the prior art.

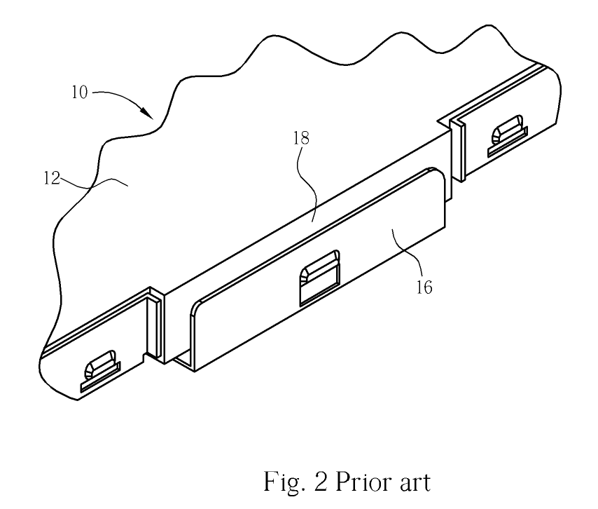

FIG. 3 is a diagram of an edge-type backlight module of the first embodiment according to the present invention.

FIG. 4 illustrates the combination of a light guide plate and a backing plate of the edge-type backlight module of the first embodiment according to the present invention.

FIG. 5 is a lateral view of the combination of the light guide plate and the backing plate of the edge-type backlight module of the first embodiment according to the present invention.

FIG. 6 is a diagram of an edge-type backlight module of the second embodiment according to the present invention.

FIG. 7 illustrates the combination of a light guide plate and a backing plate of the edge-type backlight module of the second embodiment according to the present invention.

FIG. 8 is a lateral view of the combination of the light guide plate and the backing plate of the edge-type backlight module of the second embodiment according to the present invention.

FIG. 9 is a diagram of an edge-type backlight module of the third embodiment according to the present invention.

### DETAILED DESCRIPTION

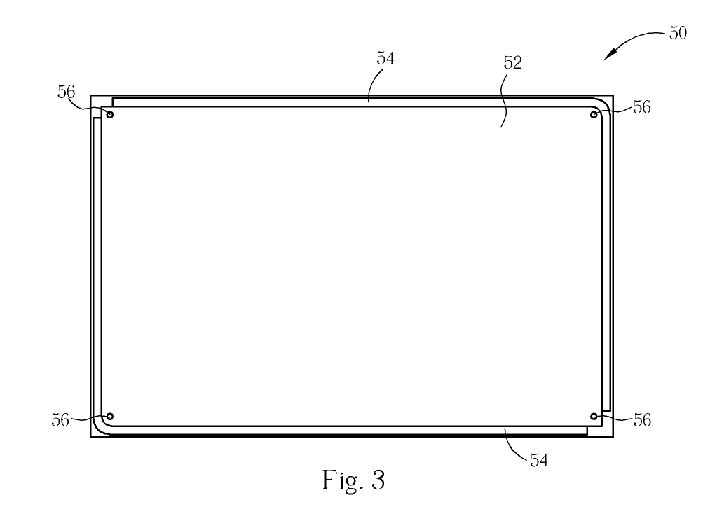

Please refer to FIG. 3. FIG. 3 is a diagram of an edge-type backlight module 50 of the first embodiment according to the present invention. The edge-type backlight module 50 includes a light guide plate 52, and two L-shaped fluorescent tubes 54 installed on the lateral sides of the light guide plate 52. The two L-shaped fluorescent tubes 54 are positioned diagonally so light can be emitted into the light guide plate 52 from the four lateral sides of the light guide plate 52. The L-shaped fluorescent tube 54 can be a cold cathode fluorescent lamp (CCFL). Four first lock mechanisms 56 are installed on the four corners of the light guide plate 52. The light guide plate 52 can be manufactured with injection molding. The first lock mechanisms 56 can be nuts, and the first lock mechanisms 56 can be located on the four corners in advance so as to be combined with the light guide plate 52 tightly after an injection molding process of the light guide plate 52.

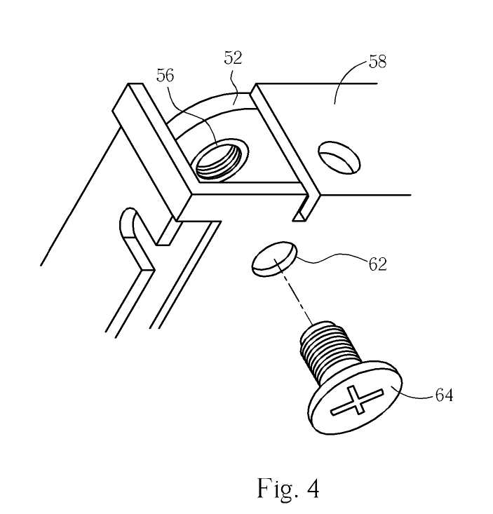

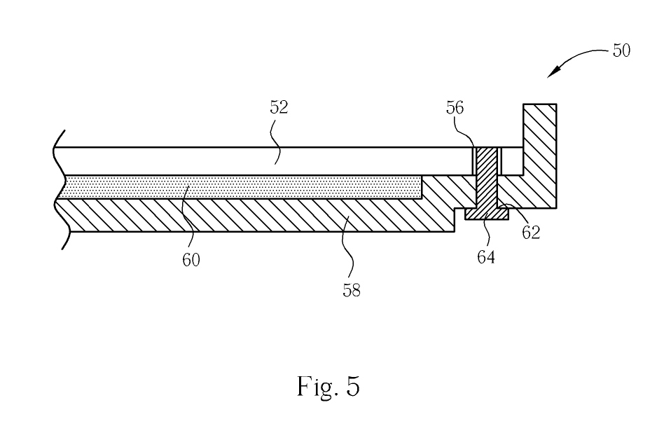

Please refer to FIG. 4 and FIG. 5. FIG. 4 illustrates the combination of the light guide plate 52 and a backing plate 58 of the edge-type backlight module 50 of the first embodiment according to the present invention. FIG. 5 is a lateral view of the combination of the light guide plate 52 and the backing plate 58 of the edge-type backlight module 50 of the first embodiment according to the present invention. The backing plate 58 is installed below the light guide plate 52 for covering the light guide plate 52 and internal components of the edge-type backlight module 50. The edge-type backlight module 50 further includes a reflecting sheet 60 installed between the backing plate 58 and the light guide plate 52 for reflecting light emitted through the light guide plate 52 downward back to the light guide plate 52 so as to increase the light utility rate. Four openings 62 are located in positions on the backing plate 58 corresponding to positions where the first lock mechanisms 56 are located respectively. The edge-type backlight module 50 further includes four second lock mechanisms 64 for fixing the light guide plate 52 and the backing plate 58 with the first lock mechanisms 56 in a locking manner. The second lock mechanisms 64 can be bolts for passing through the openings 62 of the backing plate 58 and fastening with the first lock mechanisms 56 inwardly respectively. Therefore there is no gap between the light guide plate 52 and the backing plate 58 of the edge-type backlight module 50 by the lock mechanism so that the vibration and impulse resistance strength can be increased.

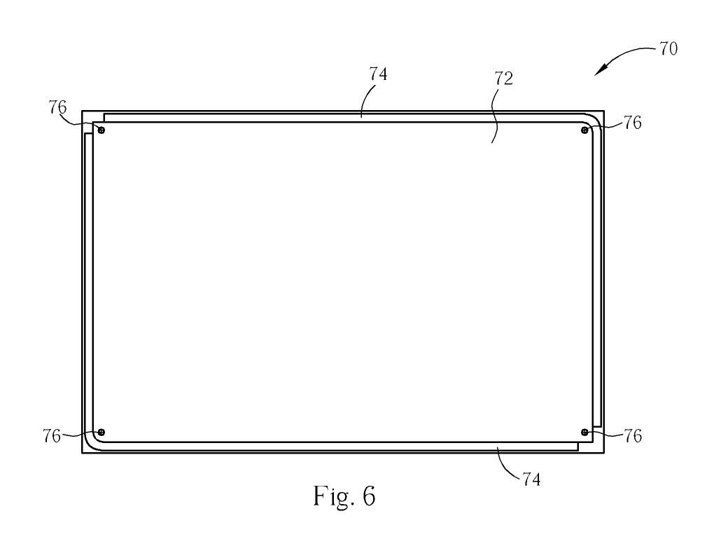

Bolts also can be located on the four corners in advance so as to be combined with the light guide plate tightly after an injection molding process of the light guide plate, and then nuts are fastened with the bolts so as to combine the light guide plate with the backing plate. Please refer to FIG. 6. FIG. 6 is a diagram of an edge-type backlight module 70 of the second embodiment according to the present invention. The edge-type backlight module 70 includes a light guide plate 72, and two L-shaped fluorescent tubes 74 installed on the lateral sides of the light guide plate 72. The two L-shaped fluorescent tubes 74 are positioned diagonally so light can be emitted into the light guide plate 72 from the four lateral sides of the light guide plate 72. The L-shaped fluorescent tube 74 can be a cold cathode fluorescent lamp (CCFL). Four first lock mechanisms 76 are installed on the four corners of the light guide plate 72. The light guide plate 72 can be manufactured with injection molding. The first lock mechanisms 76 can be bolts, and the first lock mechanisms 76 can be located on the four corners in advance so as to be combined with the light guide plate 72 tightly after an injection molding process of the light guide plate 72.

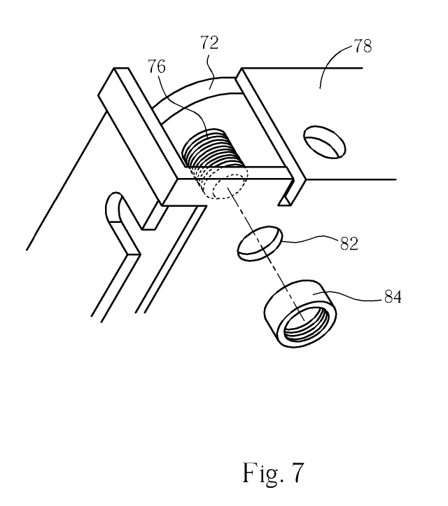

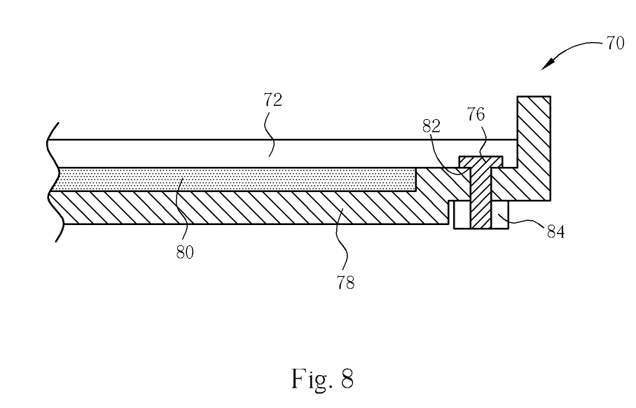

Please refer to FIG. 7 and FIG. 8. FIG. 7 illustrates the combination of the light guide plate 72 and a backing plate 78 of the edge-type backlight module 70 of the second embodiment according to the present invention. FIG. 8 is a lateral view of the combination of the light guide plate 72 and the backing plate 78 of the edge-type backlight module 70 of the second embodiment according to the present invention. The backing plate 78 is installed below the light guide plate 72 for covering the light guide plate 72 and internal components of the edge-type backlight module 70. The edge-type backlight module 70 further includes a reflecting sheet 80 installed between the backing plate 78 and the light guide plate 72 for reflecting light emitted through the light guide plate 72 downward back to the light guide plate 72 so as to increase the light utility rate. Four openings 82 are located in positions on the backing plate 78 corresponding to positions where the first lock mechanisms 76 are located respectively. The edge-type backlight module 70 further includes four second lock mechanisms 84 for fixing the light guide plate 72 and the backing plate 78 with the first lock mechanisms 76 in a locking manner. The second lock mechanisms 84 can be nuts for locking with the first lock mechanisms 76 passing through the openings 82 of the backing plate 78 respectively.

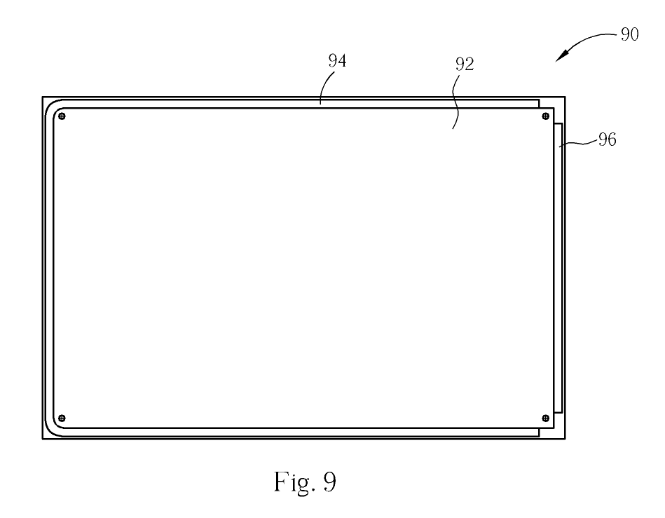

In conclusion, the combination of the light guide plate and the backing plate of the edge-type backlight module according to the present invention is made by a lock mechanism instead of utilizing an ear part mechanism of the prior art. Therefore there is no limitation in positioning a light source as there was with the prior art structure. The edge-type backlight module of the present invention can apply multiple light sources from lateral sides of the light guide plate, and the light source is not limited to the L-shaped fluorescent tube mentioned above. For example, the light sources can be a U-shaped fluorescent tube plus a straight fluorescent tube. Please refer to FIG. 9. FIG. 9 is a diagram of an edge-type backlight module 90 of the third embodiment according to the present invention. The edge-type backlight module 90 includes a light guide plate 92, a U-shaped fluorescent tube 94, and a straight fluorescent tube 96. The U-shaped fluorescent tube 94 and the straight fluorescent tube 96 are installed on the lateral sides of the light guide plate 92 and are positioned around the lock mechanisms of the edge-type backlight module 90 so that light can be emitted into the light guide plate 92 from the four lateral sides of the light guide plate 92. The lock mechanisms of the edge-type backlight module 90 are the same as the lock mechanisms of the above-mentioned embodiments.

The quantity and the location of the first lock mechanism and the second lock mechanism of the edge-type backlight module according to the present invention depend on the design preferences. However, there is a trade-off between the lock strength and the increased cost of installing extra lock mechanisms.

In contrast to the conventional edge-type backlight module, the edge-type backlight module according to the present invention utilizes the lock mechanism to combine the light guide plate and the backing plate so that there is no gap between the light guide plate and the backing plate and so that the vibration and impulse resistance strength can be increased. Furthermore, the combination of the light guide plate and the backing plate according to the present invention is made by a lock mechanism instead of utilizing an ear part mechanism of the prior art, so there is no limitation in positioning light source due to the prior structure. The edge-type backlight module according to the present invention can apply multiple light sources from lateral sides of the light guide plate so that the illuminance of the edge-type backlight module according to the present invention can be increased.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An edge-type backlight module comprising:
a light guide plate comprising a first lock mechanism;
a backing plate installed on one side of the light guide plate comprising at least one opening located in a position corresponding to a position where the first lock mechanism is located; and
a second lock mechanism for fixing the light guide plate and the backing plate with the first lock mechanism in a locking manner.

2. The edge-type backlight module of claim 1 wherein the first lock mechanism is a nut and the second lock mechanism is a bolt for passing through the opening of the backing plate and fastening with the nut.

3. The edge-type backlight module of claim 1 wherein the first lock mechanism is a bolt and the second lock mechanism is a nut for locking with the bolt passing through the opening of the backing plate.

4. The edge-type backlight module of claim 1 further comprising a reflecting sheet installed between the backing plate and the light guide plate for reflecting light emitted through the light guide plate downward back to the light guide plate.

5. The edge-type backlight module of claim 1 further comprising a fluorescent tube installed on the lateral side of the light guide plate.

6. The edge-type backlight module of claim 1 wherein the fluorescent tube is an L-shaped fluorescent tube.

7. The edge-type backlight module of claim 1 wherein the fluorescent tube is a U-shaped fluorescent tube.

8. The edge-type backlight module of claim 1 wherein the light guide plate is manufactured with injection molding.
